(19) United States
(12) Patent Application Publication
(10) Pub. No.: US 2012/0291905 A1
(43) Pub. Date: Nov. 22, 2012

(54) CONNECTOR FOR A FLUID LINE AND FLUID LINE

(75) Inventors: Carsten ECKARDT, Bruchkoebel (DE); Knut SEIBEL, Altenstadt (DE); Bruno JACKSTEIT, Hammersbach (DE); Cameron READ, Hanau (DE); Andreas BAUER, Obernburg (DE); Stephan MANN, Biebergemuend (DE)

(73) Assignee: NORMA GERMANY GMBH, Maintal (DE)

(21) Appl. No.: 13/461,305

(22) Filed: May 1, 2012

(30) Foreign Application Priority Data
May 20, 2011 (DE) 102011102154.3

(51) Int. Cl. F16L 21/02; B23P 11/00; F16L 13/00; F16L 19/02; F16L 13/02; F16L 9/00; B32B 7/04

(52) U.S. Cl. 138/109; 29/428; 156/91; 285/335; 285/354; 285/288.1; 285/285.1

(57) ABSTRACT

Connector for a fluid line, a fluid line and a method of forming a fluid line. The connector includes a housing having an outlet opening through which at least one auxiliary element is guidable out of the housing, a pipe connection connectable to a pipe, a connection geometry connectable to a counter element, and an elastomeric body structured and arranged so that the at least one auxiliary element is guidable therethrough in a passage direction. The elastomeric body is structured so that, in the event of an application of pressure parallel to the passage direction, the elastomeric body expands perpendicularly to the passage direction.

### CROSS-REFERENCE TO RELATED APPLICATIONS

The present application claims priority under 35 U.S.C. §119 of German Patent Application No. 10 2011 102 154.3, filed on May 20, 2011, the disclosure of which is expressly incorporated by reference herein in its entirety.

### BACKGROUND OF THE INVENTION

1. Field of the Invention

Embodiments of the invention relate to a connector for a fluid line with a housing that has a pipe connection, which can be connected to a pipe, and a connection geometry, which can be connected to a counter element.

Furthermore, the invention relates to a fluid line with a connector of this type.

Embodiments described below include applications in a motor vehicle, but it is understood that other embodiments can be applied with other fluid lines and connectors.

2. Discussion of Background Information

With a motor vehicle it is often necessary to transport a fluid, in particular a liquid, from a storage container to a point of consumption. One example of this is urea, which is used in connection with diesel engines in order to reduce nitrogen oxides. A fluid line of this type connects the tank to the point of consumption. At least at its two ends it is often provided with a connector, with the aid of which a connection can be produced between the fluid line and the tank or a pump. The tank and the pump then have a counter element, for example, a pipe connection, which can be brought into engagement with the connection geometry. The pipe, which can also be embodied or formed as a hose or another line, is connected to the housing of the connector via the pipe connection.

In some cases of application, it is desirable to have a predetermined device in the interior of the fluid line. However, this device must communicate with the outside, so that it is necessary to guide out of the fluid line an auxiliary element that is connected to the device or even forms this device. One example of a device of this type is a heating device. However, the device can also be a sensor that detects, for example, pressure, temperature, flow rate, viscosity or the like of a medium inside the fluid line.

The fluid in the fluid line is often under a pressure that is greater than the pressure in the environment of the fluid line. This leads to the risk of a leak at the point where the auxiliary element is guided out of the fluid line.

### SUMMARY OF THE INVENTION

Embodiments of the invention guide an auxiliary element out of the fluid line in such a manner that the risk of a leak is low.

Accordingly, a connector of the type mentioned at the outset includes a housing having an outlet opening through which at least one auxiliary element is guided out of the housing to the outside. The auxiliary element is guided through an elastomeric body, which, in the event of an application of pressure parallel to the passage direction of the auxiliary element through the elastomeric body, expands perpendicularly to the passage direction.

Thus, first of all the connector is selected as the element through which the auxiliary element is guided from the interior of the fluid line to the outside. In this context, the housing of the connector is considered to be stable enough in order to be able to apply the necessary compression forces. In the housing, an outlet opening is provided, through which the auxiliary element is guided in a sealed manner. A special elastomeric body is selected for the seal, which due to an internal stress already bears with a certain tightness against the edge of the outlet opening, i.e., a section of the housing surrounding the outlet opening, as well as against the auxiliary element. In order to guarantee the tightness even with greater pressures in the interior of the fluid line, the elastomeric body that forms the seal has the property that in the event of an “axial” compression, i.e., compression parallel to the passage direction, it exhibits a radial expansion so that it expands towards the housing section that surrounds the outlet opening as well as towards the auxiliary element. The greater the pressure in the interior of the fluid line, the greater also the forces that press the elastomeric body against the edge of the outlet opening and against the auxiliary element. Thus, the tightness increases with increasing pressure. The risk of a leak is therefore kept low even with larger pressures.

Preferably, it is provided that the elastomeric body is held in the outlet opening by a holding device. The holding device is used to absorb the forces acting on the elastomeric body in the case of higher pressures in the interior of the fluid line, so that the elastomeric body in fact can be compressed parallel to the passage direction and does not leak outwards. The sealing function of the elastomeric body is uncoupled from the holding function. The elastomeric body can be pressed against the holding device so that it can expand even better radially inwards and outwards and thus the tightness is improved.

Preferably, the elastomeric body is formed of a constant-volume material. In the case of a constant-volume material, compression in one direction does not lead or does not lead substantially to a reduction of the volume, but instead to an expansion of the body in other directions. Since in the present case a compression can take place virtually only parallel to the passage direction, only the two directions radially outwards and radially inwards remain for the expansion, that is, towards the edge of the outlet opening and towards the auxiliary element.

Preferably, the elastomeric body has a larger diameter at the outlet opening than in the interior of the housing. This has the advantage that the sealing can already take place in the interior of the housing. If a pressure is exerted there on the elastomeric body, this pressure is converted virtually directly to ensure that the elastomeric body bears closely against the circumferential wall of the outlet opening and bears closely against the auxiliary element.

Preferably, the elastomeric body has a conically tapering enlargement section. This conically tapering enlargement section can be used to generate a certain radial preloading during the insertion of the elastomeric body so that the elastomeric body inserted into the outlet opening seals with a certain preload radially outwards, by bearing tightly against the circumferential wall of the outlet opening, as well as radially inwards, by bearing tightly against the auxiliary element.

It is also advantageous if the elastomeric body has a step. A step prevents the elastomeric body from being inserted too far into the housing.

Preferably, the outlet opening is arranged in an outlet connection. Thus, there is sufficient length available in the housing to accommodate the elastomeric body without the housing otherwise having to be embodied or formed with too much material. The outlet connection can form a tubular section of the housing, for example.

Preferably, the outlet connection has a length parallel to the passage direction that is greater than the length of the elastomeric body parallel to the passage direction. The elastomeric body then does not interfere with a through channel through the connector so that the flow of the fluid flowing through the fluid line is not impeded by the elastomeric body.

Preferably, the holding device has a press ring. The press ring is able to act on the elastomeric body in a flat manner so that it can absorb the pressures acting on the elastomeric body. Thus, the press ring holds the elastomeric body securely in the housing of the connector and serves as counter bearing for the compression of the elastomeric body by the pressures in the interior of the fluid line.

Preferably, the press ring is held in the outlet opening by an undercut. The press ring can be pressed into the outlet opening, for example, such that the outlet opening is temporarily enlarged during the pressing-in, but then springs radially inwards again. The press ring is then held securely in the housing without additional expenditure.

Preferably, the holding device has a cap that covers the outlet opening at least in part and is screwed, pushed, pressed, adhered or welded onto the housing. When the cap is screwed onto the housing, a corresponding screw thread is needed in the cap and on the housing. In the case of pushing on, a different connection geometry is necessary which permits a positive closure. It must hereby be possible to temporarily widen the cap radially and for it then to spring back over the connection geometry. When the cap is pressed on, it is held in principle by friction. In the case of adhesion or welding, a closure by adhesive force results between the cap and the housing. In all cases, the cap is able to apply the necessary holding forces so that the elastomeric body is not pressed out of the housing when an increased pressure prevails in the fluid line, and forms a counter bearing in order to produce the desired compression of the elastomeric body. The cap can be used with or without a press ring.

Preferably, the holding device has an overmold of the housing. When the auxiliary element is guided out of the outlet opening and the elastomeric body has been inserted into the outlet opening, the connector can then be inserted into an injection mold, for example, and a plastic can be injected in order to generate the overmold. This is also one way of holding the elastomeric body (with or without a press ring) in the outlet opening and of applying the opposing forces necessary for the compression.

It is hereby preferred for the overmold to encompass the housing on the side lying opposite the outlet opening. This results in a positive closure of the overmold plastic, which also holds the elastomeric body in the outlet opening against greater forces.

Preferably, the overmold at least in part covers the pipe connection. The overmold can then also be used to cover from outside a pipe pushed onto the pipe connection, so that the pipe is held even better on the pipe connection.

Preferably, the auxiliary element is formed by an electric cable. An electric cable of this type can, for example, conduct electric power to a heating device that is arranged in the fluid line. The electric cable can also be used to conduct measurement data to the outside from a sensor that is arranged in the fluid line. It is often favorable when an electric cable is used, to guide two wire conductors through separate through openings in the elastomeric body in order to ensure the tightness with high reliability.

The invention also relates to a fluid line with a connector, as described above, and a pipe attached to the pipe connector. The auxiliary element, for example, the electric cable, can then also be guided through the connector far into the interior of the pipe.

Embodiments of the invention are directed to a connector for a fluid line that includes a housing having an outlet opening through which at least one auxiliary element is guidable out of the housing, a pipe connection connectable to a pipe, a connection geometry connectable to a counter element, and an elastomeric body structured and arranged so that the at least one auxiliary element is guidable therethrough in a passage direction. The elastomeric body is structured so that, in the event of an application of pressure parallel to the passage direction, the elastomeric body expands perpendicularly to the passage direction.

In accordance with embodiments of the invention, a holding device may be structured and arranged to hold the elastomeric body in the outlet opening.

According to other embodiments of the instant invention, the elastomeric body can be formed of a constant-volume material.

In accordance with still other embodiments, the elastomeric body can have a larger diameter at the outlet opening than in an interior of the housing. The elastomeric body may include a conically tapering enlargement section. Further, the elastomeric body may include a step.

According to further embodiments, an outlet connection may include the outlet opening. The outlet connection can have a length extending parallel to the passage direction that is greater than a length of the elastomeric body in a direction parallel to the passage direction.

In accordance with still other features, the holding device may include a press ring. The outlet opening may include an undercut structured to hold the press ring. The holding device can have a cap that covers the outlet opening at least in part and that can be one of screwed, pushed, pressed, adhered or welded onto the housing. Further, the holding device may include an overmold of the housing. The overmold can encompass the housing on a side lying opposite the outlet opening. The overmold can be structured to at least in part cover the pipe connection.

According to still other embodiments, the auxiliary element may include an electric cable.

Embodiments of the invention are directed to a fluid line that includes a connector as described above and a pipe attached to the pipe connection.

Embodiments of the instant invention are directed to a method of forming a fluid line. The method includes guiding the auxiliary element through an outlet opening in a connector housing, guiding the auxiliary element through an elastomeric body in a passage direction, and placing the elastomeric body into the outlet opening. The elastomeric body is structured so that pressure exerted against the elastomeric body in a direction of the passage direction results in expansion of the elastomeric body in a direction perpendicular to the passage direction.

According to other embodiments of the invention, the method can also include at least in part covering the outlet opening with a cap that is one of screwed, pushed, pressed, adhered, or welded onto the housing.

The method can also include sliding a pipe onto the connector housing.

In accordance with still yet another embodiment of the present invention, the elastomeric body can be shorter in the passage direction than a longitudinal extent of an outlet connection coupled to the pipe connection, and the outlet connection can include the outlet opening.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a longitudinal section through a first embodiment of a connector;

FIG. 2 illustrates a longitudinal section through a second embodiment of a connector;

FIG. 3 illustrates the connector from FIG. 1 in a perspective representation;

FIG. 4 illustrates a modified embodiment compared to FIG. 3; and

FIG. 5 illustrates a longitudinal section through a simplified embodiment of a connector.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

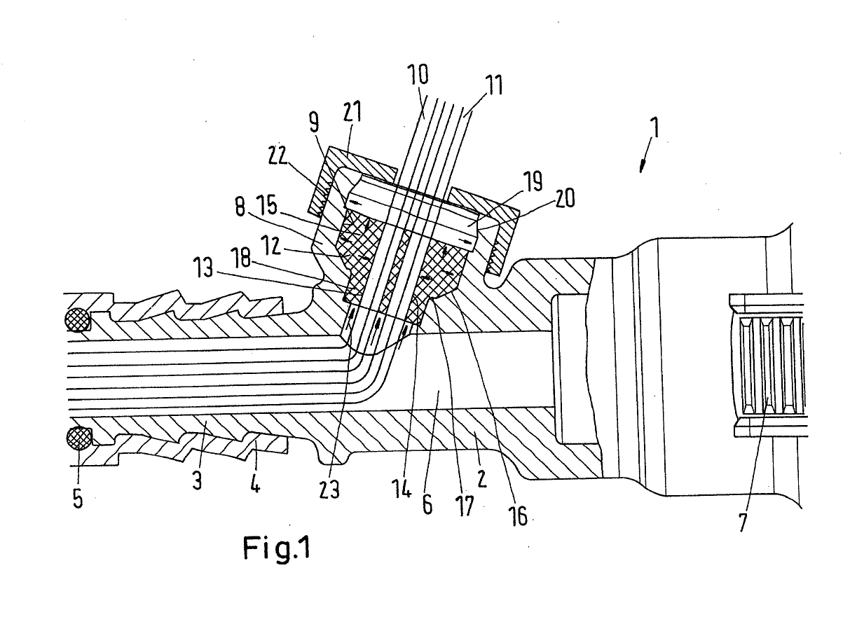

FIG. 1 shows a connector 1 for a fluid line with a housing 2, which has a pipe connection 3. A pipe 4 is pushed onto the pipe connection 3. Elements not shown in further detail can be provided to hold pipe 4, which can also be embodied or formed as a flexible line or a hose, on pipe connection 3. A sealing ring 5 ensures an additional sealing between pipe connection 3 and the pipe 4. Moreover, pipe connection 3 has a “pine tree” structure.

A through channel 6 runs through pipe connection 3 up to a connection geometry 7 located at an end of housing 2 that opposite pipe connection 3. Connection geometry 7, which is only diagrammatically shown, can be used to connect connector 1 to a counter element, e.g., a pipe connection of a tank or a pump (not shown). Connection geometry 7 should ensure a mechanically loadable and tight connection. For the present invention its precise design is of secondary importance.

Housing 2 has an outlet connection 8, which surrounds an outlet opening 9. Two wire conductors 10, 11 are guided through outlet opening 9 to an electric line, which extends through through channel 6 into the interior of pipe 4. Wire conductors 10, 11 of the electric line can lead, for example, to a sensor, with the aid of which temperature, pressure, flow rate or the like of a fluid that flows through pipe 4 and connector 1 can be detected. Wire conductors 10, 11 can also be used to conduct electric power to a heating device, not shown in greater detail, which is arranged in the interior of pipe 4.

In order to be able to guide wire conductors 10, 11 out of the interior of housing 2 to the outside in a sealed manner, an elastomeric body 12 located in pipe connection 8 provides a sealing function.

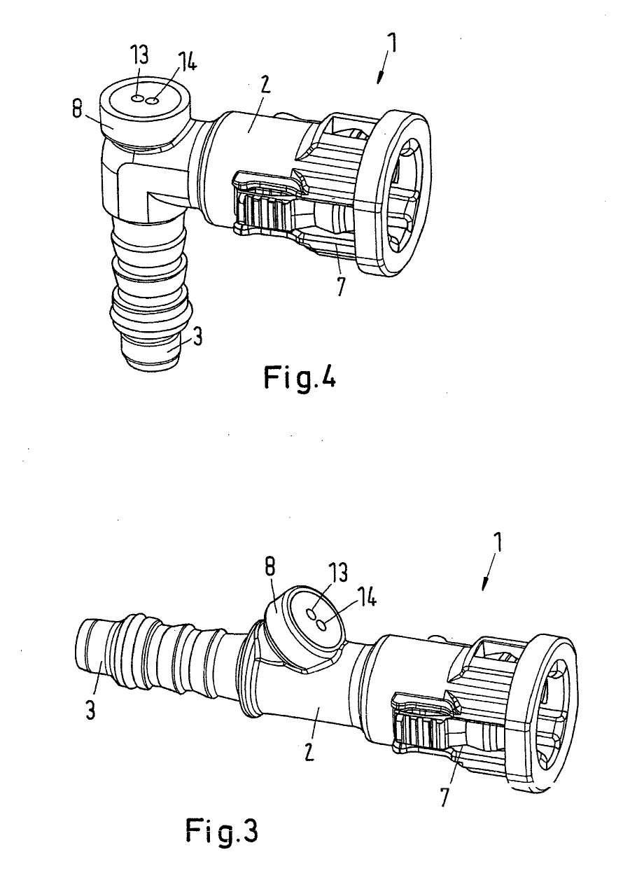

The elastomeric body 12 has a through opening 13, 14 for each wire conductor 10, 11 (see also FIG. 3). In order to simplify the following explanation, the longitudinal direction of the through openings 13, 14 is also referred to as “passage direction.” The passage direction in the present case coincides with an axis of the outlet connection 8.

Elastomeric body 12 has a cylindrical section 15, which is adjacent to the end of outlet connection 8 facing away from housing 2. Cylindrical section 15 merges into a conical section 16. Conical section 16 is followed by a small step 17 to which a further cylindrical section 18 adjoins. Cylindrical section 18 has a smaller diameter than cylindrical section 15.

As long as elastomeric body 12 is located outside outlet connection 8, it has a small excess at least in the region of cylindrical section 15 with the larger diameter. For assembly in connector 1, elastomeric body 12 is pushed over the two wire conductors 10, 11, which protrude out of outlet opening 9 and then is pressed into outlet opening 9. Conical section 16 makes it easier to press elastomeric body 12 into outlet connection 8. During this pressing in, the elastomeric body 12 is slightly compressed radially, that is, perpendicular to the passage direction, so that it bears tightly against the circumferential wall of outlet opening 9. Due to the radial compression, it will also bear tightly against the circumferential surfaces of wire conductors 10, 11. Step 17 prevents the elastomeric body 12 from being pushed too far into outlet connection 8.

In order to hold elastomeric body 12 in outlet connection 8, a press ring 19 is provided, which can be snapped in behind an undercut 20. The press ring likewise has two through openings for the two wire conductors 10, 11.

Press ring 19 is also held in outlet connection 8 by a cap 21, in addition to the positive closure that is formed by undercut 20. Cap 21, as shown, can have a threaded assembly 22, with which it is attached to outlet connection 8. Alternatively, other types of attachment can be used. For instance, cap 21 can also be only pressed onto outlet connection 8, i.e., held there by friction connection. A positive connection can be generated by pushing cap 21 onto outlet connection 8. Projections and recesses that are necessary for this purpose, are not shown in FIG. 1. Cap 21 can also be adhered or welded to outlet connection 8, i.e., a closure by adhesive force can be formed.

As already stated above, due to the pressing of elastomeric body 12 into outlet connection 8, a certain tightness already results, which, however, is not necessarily sufficient for the pressures prevailing in through channel 6. These pressures are represented by arrows 23.

With a compression in one direction, the material of elastomeric body 12 now has the property of expanding in other available directions. In the extreme case, elastomeric body 12 can be made of a constant-volume material in which a compression in one direction does not lead to a reduction in volume, instead the corresponding shortening in this direction would lead to an increase of the dimensions in the other directions.

In the present case, the material properties of elastomeric body 12 leads to the following result: when elastomeric body 12 is acted on by pressure 23 in the interior of the housing 2, it is pressed against press ring 19, which results in a compression in the passage direction. This compression then leads to an expansion in the radial direction, i.e., perpendicularly to the passage direction. In other words, elastomeric body 12 tries to expand radially outwards to bear still more closely against the circumferential wall of outlet opening 9. At the same time, elastomeric body 12 is also expanded radially inwards to bear more closely against the circumferential surfaces of wire conductors 10, 11. The more tightly elastomeric body 12 bears against the corresponding mating surfaces, i.e., the greater the forces with which elastomeric body 12 bears against these mating surfaces, the better the seal. Thus, the tightness virtually increases with the pressure in the interior of housing 2, so that there is a sufficient tightness even with higher pressures in the interior of the housing.

Outlet connection 8 has a length parallel to the passage direction that is greater than the length of the elastomeric body 12 parallel to the passage direction. This prevents elastomeric body 12 from projecting into through channel 6 and impeding the flow of a fluid through through channel 6.

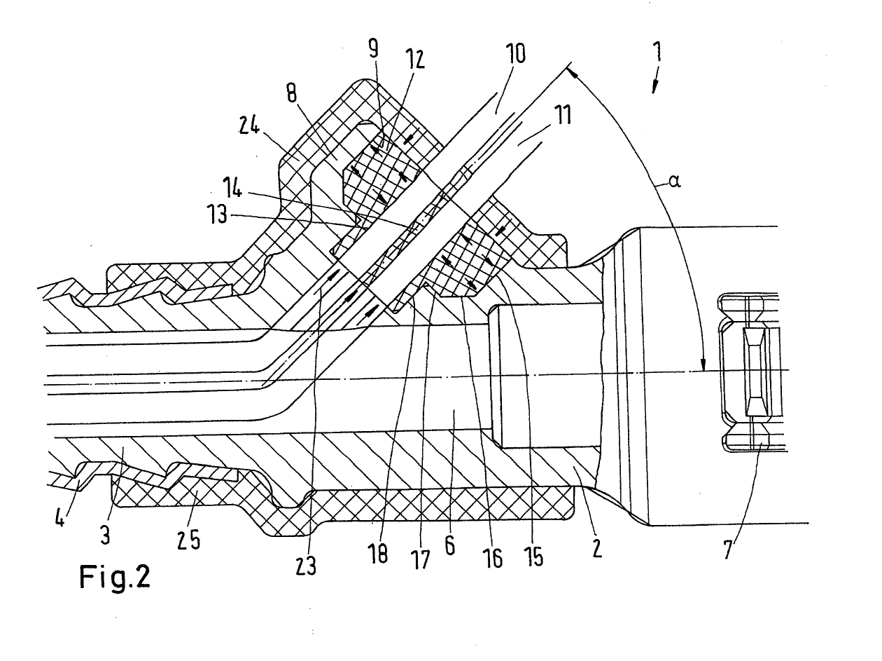

FIG. 2 shows a modified embodiment in which identical parts and parts with identical functions are provided with the same reference numbers.

Here too the outlet connection 8 is at an angle α to the through channel 6. The angle α can be in the range of, e.g., 20° to 80°.

In the embodiment according to FIG. 2, elastomeric body 12 extends up to the end of outlet connection 8. In order to hold elastomeric body 12 in outlet opening 9, housing 2 of connector 1 is provided with an overmold 24. Overmold 24 covers elastomeric body 12 completely apart from the area regions through which wire conductors 10, 11 pass.

Overmold 24 also covers pipe connection 3 and thus a part of pipe 4 which is pushed onto pipe connection 3. Overmold 24 surrounds housing 2 in the circumferential direction around through channel 6, and thus, has a section 25 that is arranged on the side of housing 2 that lies opposite outlet connection 8. Elastomeric body 12 is thus also held by a form closure in housing 2.

Overmold 24 can also be used together with a press ring 19. Overmold 24 can also be used together with a cap 21. However, in most cases, this is not necessary.

FIG. 3 shows connector 1 according to FIG. 1 from outside (without the pipe 4). It is discernible that pipe connection 3 and connection geometry 7 lie on a straight line as it were, so that through channel 6 does not contain any deflection sections or the like. A connector of this type is also referred to as a “0° connector.” The outlet connection 8 is at an angle in the range of 20° to 80° to through channel 6.

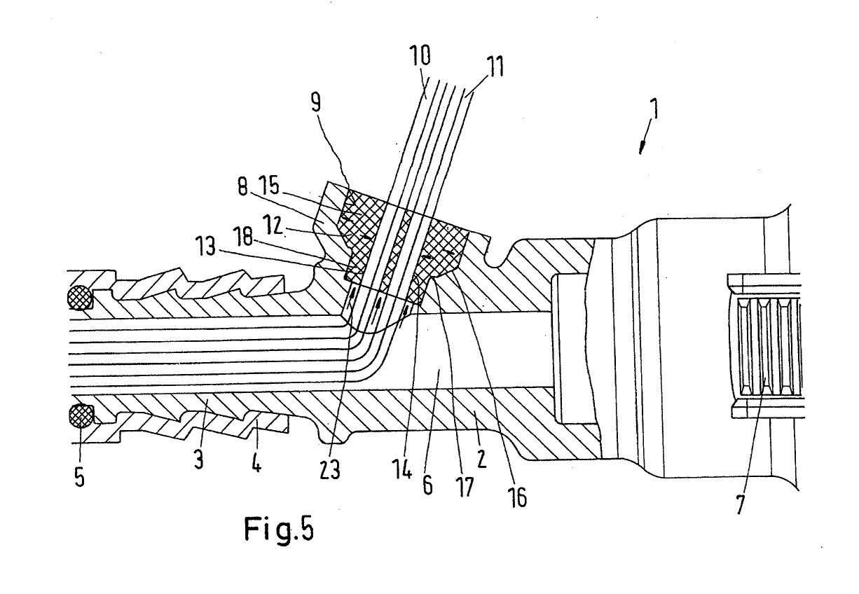

FIG. 4 shows a modified embodiment in which identical elements and elements with identical functions are provided with the same reference numbers.

Connector 1′ shown in FIG. 4 is also referred to as a “90° connector,” because housing 2′ is arranged so that pipe connection 3 and connection geometry 7 are at an angle of 90° to one another.

In this case, pipe connection 8 can have the same axis as pipe connection 3 so that wire conductors 10, 11 can be guided through through openings 13, 14 in a straight-line manner.

Naturally, other auxiliary elements can also be used instead of wire conductors 10, 11.

FIG. 5 shows an embodiment that is simplified compared to FIGS. 1 and 2. Elements that correspond to those of FIG. 1 are provided with the same reference numbers.

Elastomeric body 12′ is inserted into outlet opening 9 of outlet connection 8 without a holding device. In order to apply the necessary holding forces, it can be advantageous if elastomeric body 12′ is compressed more strongly during this insertion in the radial direction than in the embodiment according to FIG. 1. If elastomeric body 12′ then wants to expand after insertion, it holds in outlet opening 9 with correspondingly large friction forces. Optionally, it can be advantageous to provide the outlet opening with a somewhat roughened or structured surface, which, although it allows elastomeric body 12′ to be inserted into the outlet connection 8, makes it difficult to press the elastomeric body out of outlet connection 8.

In this case, too, the forces that are caused by the increased pressure inside housing 2 lead to a corresponding force on elastomeric body 12′. This force compresses elastomeric body 12′ in the passage direction because it is held in the outlet connection 8. Then the desired radial compression results with the corresponding seal at least in the region of cylindrical section 18 with smaller diameter.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A connector for a fluid line comprises:
a housing having an outlet opening through which at least one auxiliary element is guidable out of the housing;
a pipe connection connectable to a pipe;
a connection geometry connectable to a counter element;
an elastomeric body structured and arranged so that the at least one auxiliary element is guidable therethrough in a passage direction;
wherein the elastomeric body is structured so that, in the event of an application of pressure parallel to the passage direction, the elastomeric body expands perpendicularly to the passage direction.

2. The connector according to claim 1, further comprising a holding device structured and arranged to hold the elastomeric body in the outlet opening.

3. The connector according to claim 1, wherein the elastomeric body is formed of a constant-volume material.

4. The connector according to claim 1, wherein the elastomeric body has a larger diameter at the outlet opening than in an interior of the housing.

5. The connector according to claim 4, wherein the elastomeric body comprises a conically tapering enlargement section.

6. The connector according to claim 4, wherein the elastomeric body comprises a step.

7. The connector according to claim 1, further comprising an outlet connection that includes the outlet opening.

8. The connector according to claim 7, wherein the outlet connection has a length extending parallel to the passage direction that is greater than a length of the elastomeric body in a direction parallel to the passage direction.

9. The connector according to claim 2, wherein the holding device comprises a press ring.

10. The connector according to claim 9, wherein the outlet opening comprises an undercut structured to hold the press ring.

11. The connector according to claim 2, wherein the holding device has a cap that covers the outlet opening at least in part and that is one of screwed, pushed, pressed, adhered or welded onto the housing.

12. The connector according to claim 2, wherein the holding device comprises an overmold of the housing.

13. The connector according to claim 12, wherein the overmold encompasses the housing on a side lying opposite the outlet opening.

14. The connector according to claim 12, wherein the overmold is structured to at least in part cover the pipe connection.

15. The connector according to claim 1, wherein the auxiliary element comprises an electric cable.

16. A fluid line comprising:
a connector according to claim 1; and
a pipe attached to the pipe connection.

17. A method of forming a fluid line, comprising:
guiding the auxiliary element through an outlet opening in a connector housing;
guiding the auxiliary element through an elastomeric body in a passage direction;
placing the elastomeric body into the outlet opening,
wherein the elastomeric body is structured so that pressure exerted against the elastomeric body in a direction of the passage direction results in expansion of the elastomeric body in a direction perpendicular to the passage direction.

18. The method according to claim 17, further comprising at least in part covering the outlet opening with a cap that is one of screwed, pushed, pressed, adhered, or welded onto the housing.

19. The method according to claim 17, further comprising sliding a pipe onto the connector housing.

20. The method according to claim 17, wherein the elastomeric body is shorter in the passage direction than a longitudinal extent of an outlet connection coupled to the pipe connection, the outlet connection comprising the outlet opening.
